(19) United States
(12) Patent Application Publication
(10) Pub. No.: US 2007/0278816 A1
(43) Pub. Date: Dec. 6, 2007

(54) CANOPY SYSTEM FOR A UTILITY VEHICLE

(75) Inventors: Donald S. Hanson, Augusta, GA (US); Anthony R. Rossello, Grovetown, GA (US); Kent H. Bruntz, Evans, GA (US); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/421,909

(22) Filed: Jun. 2, 2006

(51) Int. Cl. B62D 25/06

(52) U.S. Cl. 296/104

(57) ABSTRACT

A retractable canopy system for a light-weight utility vehicle is provided. The system comprises a mounting frame that includes a pair of legs. An upper portion of each leg can be frictionally retained between a pair of corresponding vehicle roof support side struts. Distal ends of each mounting frame leg can be fixedly connected to a fixed structure of the vehicle. At least one deployment frame can be pivotally connected to the mounting frame legs and a canopy can be attached to the mounting frame and the deployment frame. Thus, the canopy can be transitioned between a stowed position and a deployed position by moving the deployment frame.

### FIELD

The present teachings relate to a retractable canopy system for light-weight utility vehicles.

### BACKGROUND

The statements in this section merely provide background information related to the present disclosure and may not constitute prior art.

Known light-weight utility vehicles, such as small cargo/maintenance vehicles, shuttle vehicles or golf cars, can include a canopy or hood that overhangs a portion of the vehicle. For example, golf cars can have a canopy that overhangs a rear golf bag platform and retention yoke to protect golf bags during adverse weather, e.g., rain, hail, or snow. Some known canopies are configured to be transitioned between a stowed position during desirable weather and a deployed position during adverse weather. Typically, such canopy systems include framework that is bolted to framework of the vehicle, for example struts that support the vehicle's roof. More particularly, typically holes are punched, formed or drilled into the canopy and vehicle frameworks and bolts or screws are inserted into or through the holes to secure the canopy framework to the vehicle framework. Such mounting holes weaken both the canopy and vehicle frameworks and are subject to rust and erosion, which further weakens the frameworks.

### SUMMARY

A retractable canopy system for a light-weight utility vehicle is provided. In various embodiments, the system comprises a mounting frame that includes a pair of legs. An upper portion of each leg can be frictionally retained between a pair of corresponding vehicle roof support side struts. Distal ends of each mounting frame leg can be fixedly connected to a fixed structure of the vehicle. At least one deployment frame can be pivotally connected to the mounting frame legs and a canopy can be attached to the mounting frame and the deployment frame. Thus, the canopy can be transitioned between a stowed position and a deployed position by moving the deployment frame.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is side view of a golf car including a retractable canopy system in a deployed position, in accordance with various embodiments of the present disclosure;

FIG. 2 is side view the golf car shown in FIG. 1 showing the retractable canopy system in a stowed position, in accordance with various embodiments of the present disclosure;

FIG. 3A is a side view of a frame system for the retractable canopy system in the deployed position, as shown in FIG. 1, wherein the frame system includes a binding pin retention mechanism in accordance with various embodiments of the present disclosure;

FIG. 3B is a side view of the frame system for the retractable canopy system in the stowed position, as shown in FIG. 2, wherein the frame system includes the binding pin retention mechanism shown in FIG. 3A;

FIG. 3C is a front view of the frame system in the stowed position, as shown in FIG. 3B;

FIG. 4A is a side view of a frame system for the retractable canopy system in the deployed position, as shown in FIG. 1, wherein the frame system includes a C-bracket retention mechanism in accordance with various embodiments of the present disclosure;

FIG. 4B is a side view of the frame system for the retractable canopy system in the stowed position, as shown in FIG. 2, wherein the frame system includes the C-bracket retention mechanism shown in FIG. 4A;

FIG. 4C is a front view of the frame system in the stowed position, as shown in FIG. 4B;

FIG. 5 is rear view of a portion of golf car shown in FIG. 1 illustrating an installation process of the canopy system shown in FIG. 1, in accordance with various embodiments of the present disclosure;

FIG. 6 is side view of a portion of golf car shown in FIG. 1 further illustrating the installation process of the canopy system shown in FIG. 1;

FIG. 7 is isometric rear view of a portion of golf car shown in FIG. 1 further illustrating the installation process of the canopy system shown in FIG. 1; and

FIG. 8 is side view of a portion of golf car shown in FIG. 1 further illustrating the installation process of the canopy system shown in FIG. 1.

### DETAILED DESCRIPTION

The following description is merely exemplary in nature and is in no way intended to limit the present teachings, application, or uses. Throughout this specification, like reference numerals will be used to refer to like elements.

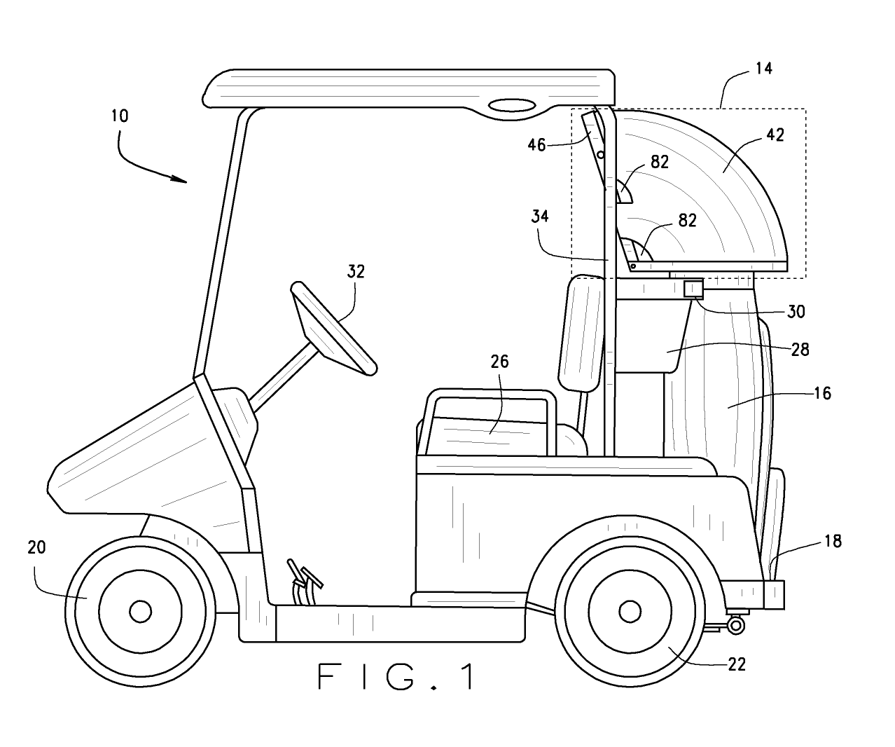

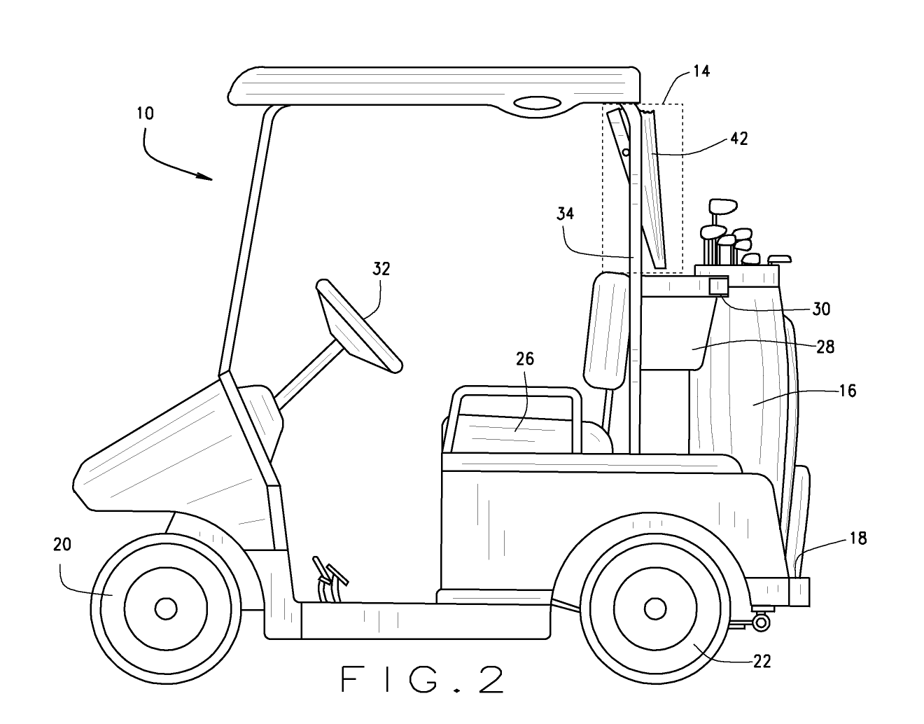

FIGS. 1 and 2 illustrate a golf car 10 including a retractable canopy system 14 in a deployed and stowed position, respectively, in accordance with the various embodiments. As described further below, the canopy system 14 is movable between a stowed position (shown in FIG. 2) and a deployed position (shown in FIG. 1). Particularly, the canopy system 14 can be placed in the deployed position to cover and protect golf bag and clubs 16 retained on a cargo platform 18 of the car 10 from foul and/or harsh weather conditions, i.e., rain, sleet, sun. The golf car 10 additionally includes a pair of front wheels 20 that operate to steer the golf car 10 and a pair of rear wheels 22, wherein at least one of the rear wheels 22 functions as a drive wheel for propelling golf car 10.

The golf car 10 further includes a seat 26 to accommodate a driver and a passenger, a utility basket 28 utilized for holding a golfer's personal items and/or golfing equipment, such as golf balls, club head covers, gloves, hats, jackets, sweaters, shoes, etc., and a golf bag yoke 30 for securing the golf clubs and bag 16 in place on the cargo platform 18. The utility basket 28 and bag yoke 30 can be separate components cooperatively coupled to a pair of roof support side struts 34, or integrally formed into a combined basket and yoke component coupled to the side struts 34. Furthermore, the golf car 10 includes a steering wheel 32 which controls a steering angle of the front wheels 20.

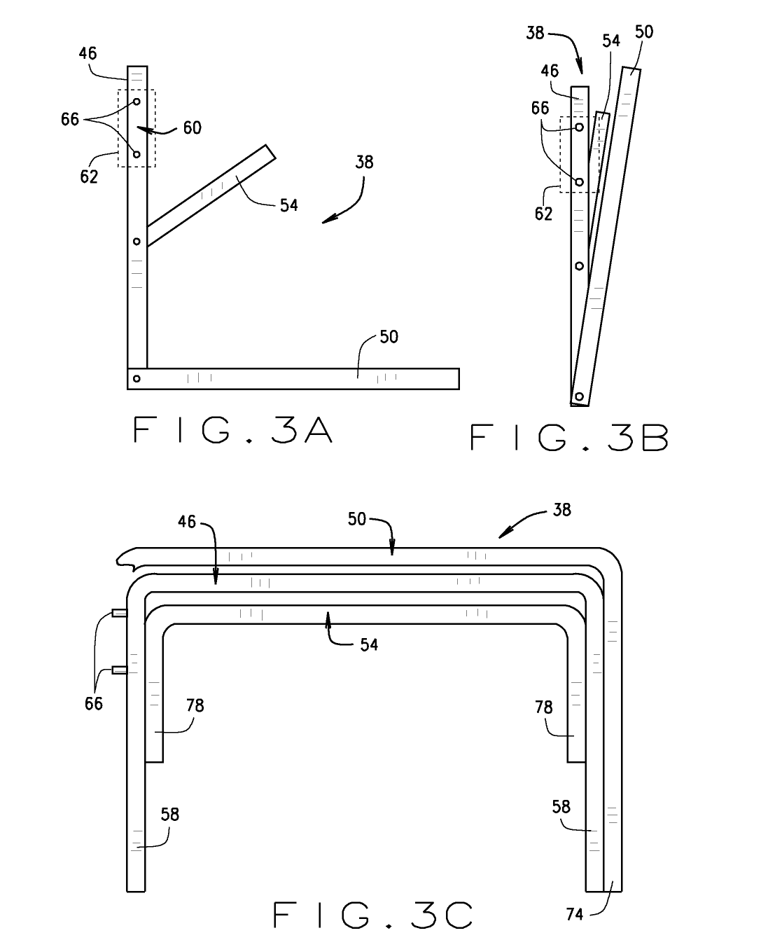

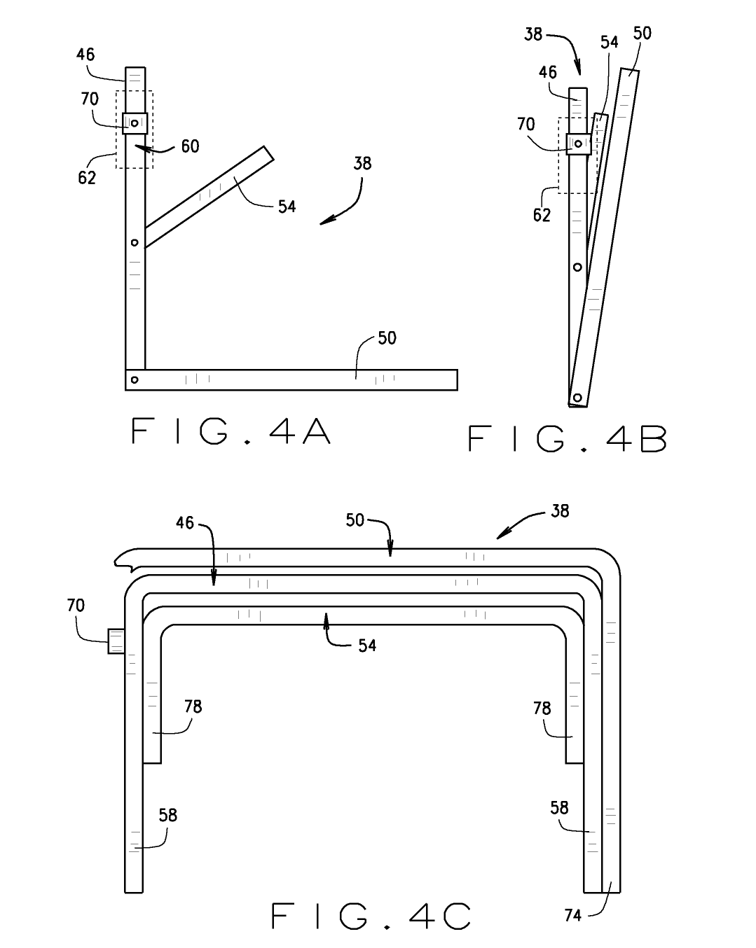

Referring to FIGS. 3A, 3B, 3C, 4A, 4B and 4C, the retractable canopy system 14 includes a frame system 38 and a cover 42 (shown in FIG. 1) that fits over and is supported by the frame system 38. In various embodiments, the frame system 38 includes a mounting frame 46, a lower deployment frame 50 and an upper deployment frame 54. Although the frame system 38 is described and illustrated herein as including two deployment frames, i.e., lower and upper deployment frames 50 and 54, it is envisioned that in various embodiments the frame system 38 can include one deployment frame or more than two deployment frames. The mounting frame 46 is generally C-shaped and includes a pair of legs 58.

An upper portion 60 of each of the mounting frame legs 58 includes a retention mechanism 62 to frictionally retain the mounting frame 46 between the roof support side struts 34, as described further below. Each retention mechanism 62 can be any mechanism, device or system suitable for frictionally retaining each mounting frame leg 58 effectively in physical communication with the corresponding roof support side struts 34. For example, as illustrated in FIGS. 3A, 3B and 3C, in various embodiments each retention mechanism 62 can include a pair of binding pins 66 mounted to each mounting frame leg 58. In other exemplary embodiments, each retention mechanism 62 can include a U or C-bracket, 70 rotationally mounted to each mounting frame leg 58, as illustrated in FIGS. 4A, 4B and 4C.

The one or more deployment frames, described herein with reference to upper and lower deployment frames 50 and 54, are pivotally connected to the mounting frame 46 at distal end portion of arms of the deployment frames, e.g., arms 74 and 78 of deployment frames 50 and 54, respectively. The deployment frames 50 and 54 are generally C-shaped to correspond with and sufficiently match the shape of the mounting frame 46. The pivotal connection and shape of the deployment frames 50 and 54 allow the deployment frames to be pivotally transitioned between the stowed and deployed positions. In the stowed position, the deployment frames 50 and 54 are ‘folded’ up to generally ‘stack’ with the mounting frame 46. That is, in various embodiments, the lower deployment frame 50 is pivotally connected to an outer side of the mounting frame legs 58, such that the lower mounting frame will pivot and collapse around the outer side of the mounting frame 46, as illustrated in FIGS. 3B, 3C, 4B and 4C. Similarly, in various embodiments, the upper mounting frame 54 is pivotally connected to an inner side of the mounting frame legs 58, such that the upper mounting frame will pivot and collapse within the inner side of the mounting frame 46, as illustrated in FIGS. 3B, 3C, 4B and 4C.

In accordance with various embodiments, the canopy system 14 is a preassembled system that is installed on the golf car 10. That is, the canopy cover 42 is mounted over the canopy frame 38 so that the canopy system 14 can be quickly and easily installed, and operationally ready, on the golf car 10, as described below, as a single unit. As illustrated in FIGS. 1 and 2, the canopy cover 42 is connected to the mounting frame 46 and the deployment frames 50 and 54 such that the canopy cover 42 covers the canopy frame system 38. The canopy cover 42 can be constructed of any suitable material that is flexible enough to allow the deployment frames to be transitioned between the stowed and deployed positions, e.g., canvas, vinyl, plastic, etc. That is, the canopy cover will collapse and fold along with the deployment frames 50 and 54 when the deployment frames 50 and 54 are transitioned from the deployed position to the stowed position, and will unfold and expand along with the deployment frames 50 and 54 when the deployment frames 50 and 54 are transitioned from the stowed position to the deployed position.

In various embodiments, the canopy cover 42 includes a hinge port 82 approximately adjacent the pivot points of the deployment frames 50 and 54, i.e., approximately adjacent the points where the deployment frame arms 74 and 78 pivotally connect to the mounting frame 46. The hinge ports 82 allow the canopy cover 42 to collapse and fold when being transitioned to the stowed position without binding or pinching between the mounting frame 46 and the deployment frames 50 and 54. Additionally, in various embodiments, the canopy cover 42 can include one or more translucent panels integrally formed with the canopy cover 42 to allow view of objects, e.g., golf clubs, covered by the canopy system 14 when in the deployed position.

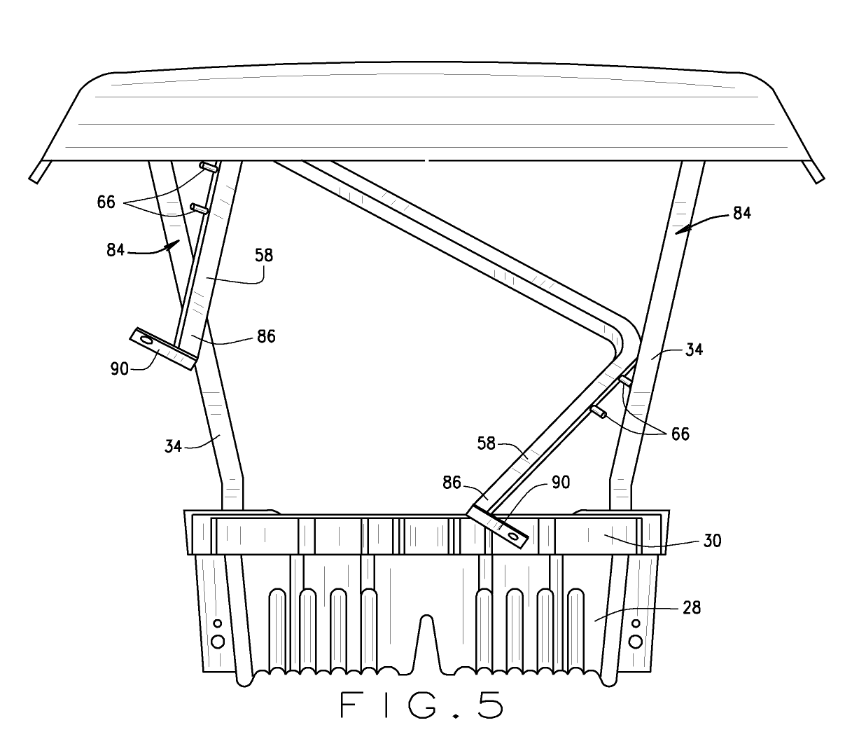

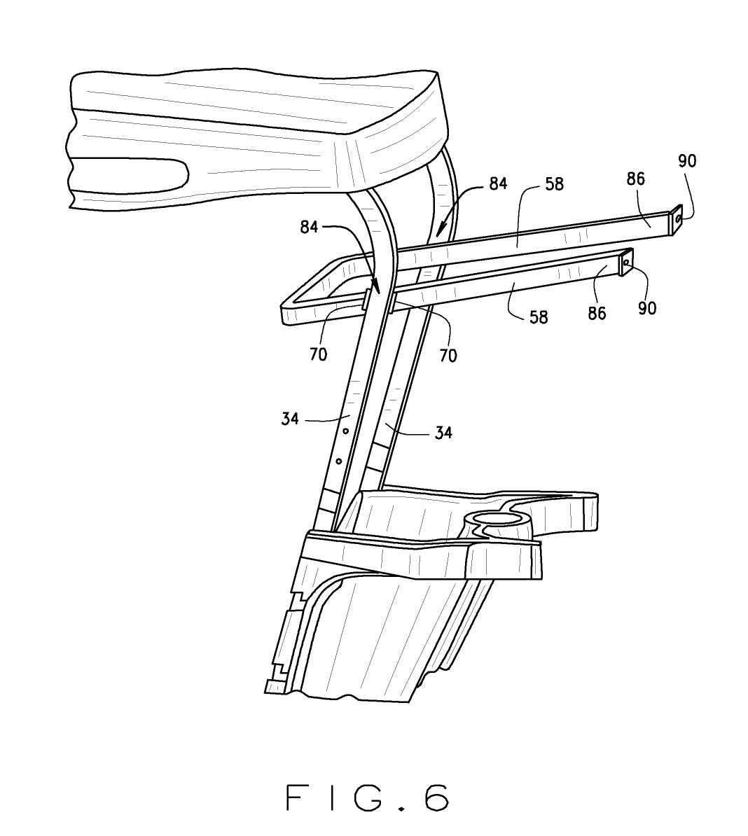

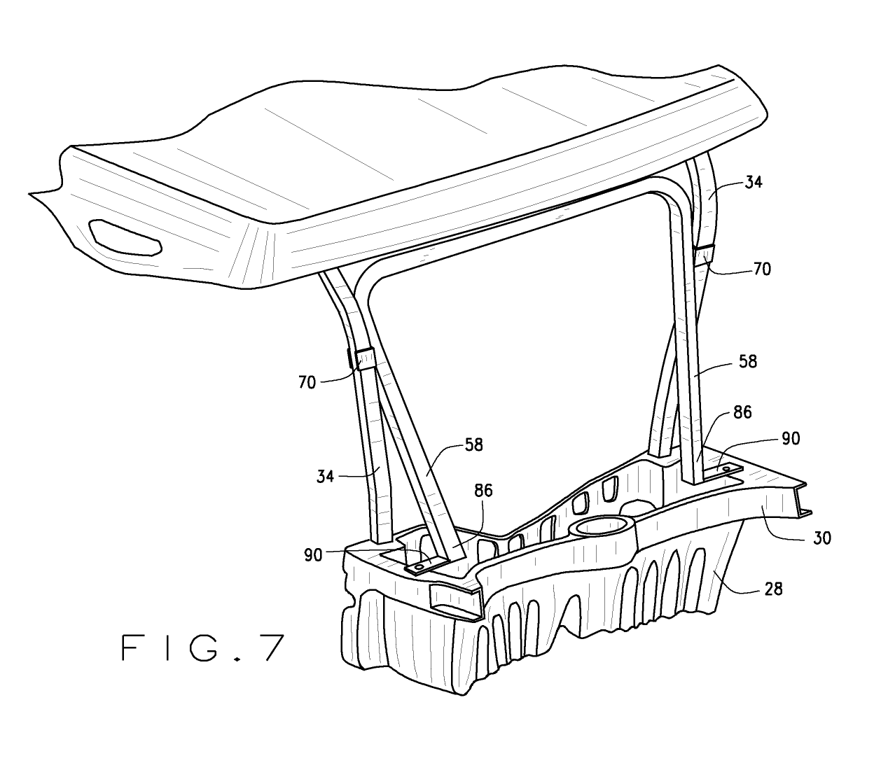

Referring now to FIGS. 5-8, an installation, or mounting, process of the canopy system 14 will now be described. The canopy system 14 is installed as a single, preassembled unit utilizing features and components of the mounting frame 46, as described below. Thus, for simplicity and clarity, the installation, or mounting, process will be described and illustrated in FIGS. 5-8 with specific reference to the mounting frame 46. More particularly, the canopy cover 42 and deployment frames 50 and 54 are removed from the illustrations in FIGS. 5-8 to more clearly illustrate how the canopy system 14 would be installed as single, preassembled unit. Thus, although the canopy cover 42 and deployment frames 50 and 54 are not shown in FIGS. 5-8, it should be understood that the canopy system 14 is installed as single, preassembled unit, having the deployment frames 50 and 54 pivotally connected to the mounting frame 46 and the canopy cover installed over the frame system 38, as described above.

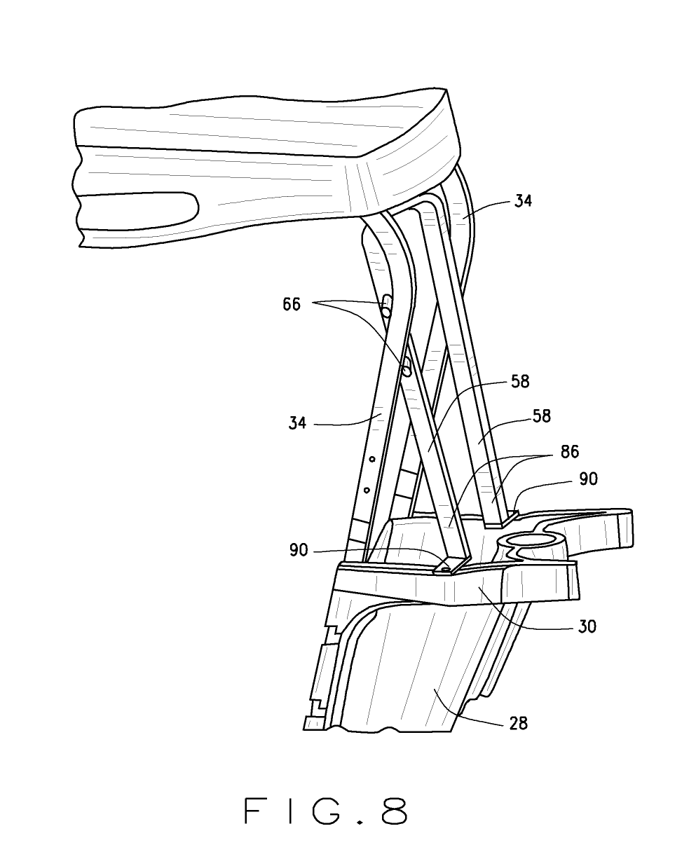

As described above, each of the mounting frame legs 58 includes a retention mechanism 62 to frictionally retain the mounting frame 46 between the roof support side struts 34. In various embodiments, each retention mechanism 62 can include a pair of binding pins 66, as shown in FIGS. 5 and 8, while in other embodiments, the retention mechanisms 62 can include U or C-brackets 70. To install the canopy system 14, the canopy system 14 is canted, or diagonally positioned, between the roof support side struts 34, as shown in FIG. 5. The retention mechanisms 62 are then aligned with the roof support side struts 34 such that retention mechanisms 62 will flank the roof support side struts 34 on forward and aft sides of the roof support side struts 34. For example, as illustrated in FIG. 5, one retention pin 66 of each mounting frame leg 58 is positioned to align behind aft sides of the roof support side struts 34 and the other retention pin 66 of each mounting frame leg 58 is positioned to align in front of forward sides of the roof support side struts 34.

The canopy system 14 is then rotated such that the mounting frame legs 58 effectively frictionally engage the respective roof support side struts 34 with roof support side struts 34 retained by the retention mechanisms. For example, the roof support side struts 34 are retained between the binding pins 66 or between legs of the U or C-bracket. With the upper portions 60 of the mounting frame legs 58 frictionally retained between upper portions 84 of the roof support side struts 34, distal ends 86 of the mounting frame legs 58 are lowered to contact a top of any suitable fixed structure of the golf car located at the rear of the golf car 10. For example, in various embodiments, the fixed structure can be the utility basket 28 and/or the yoke 30, as illustrated throughout the Figures. More particularly, the mounting frame 46 includes a mounting bracket 90 formed or connected at the distal end 86 of each mounting frame leg 58 that is lowered into contact with a top of the fixed structure, e.g., the utility basket 28 and/or the yoke 30. Each mounting bracket 90 is coupled, or fastened, to the fixed structure, e.g., the utility basket 28 and/or the yoke 30, using any suitable coupling or fastening means. For example, each mounting foot 90 could be bolted, screwed or riveted to the utility basket 28 and/or the yoke 30. The mounting bracket 90 can be any bracket or component suitable for securing coupling the distal ends 86 of each mounting frame leg 58 to the fixed structure. For example, in various embodiments, the mounting brackets 90 are flat plates formed or connected at the distal end 86 of each mounting frame leg 58.

Once each mounting bracket 90 is coupled, or fastened, to the fixed structure, e.g., the utility basket 28 and/or the yoke 30, the mounting frame upper portions 60 can not move and the retention mechanisms 62 can not disengage from the roof support side struts 34. Therefore, the mounting frame is securely connected between the roof support side struts 34 and the canopy system 14 is securely installed on the golf car 10. More particularly, to install and secure the canopy system 14 to the golf car 10 only the fastening means, e.g., nuts and bolts, are needed. The canopy system 14 is frictionally secured at the top between the roof support side struts 34, via the retention mechanisms, and secured at the bottom, via the mounting frame mounting brackets 90. Therefore, the preassembled canopy system 10 can be easily and quickly installed as an operationally ready single unit absent any roof support side strut 34 invasive fastener, i.e., without the need for holes to be formed or drilled in the roof support side struts 34, which may weaken the roof support side struts 34, and without the need for time consuming assembly of the canopy system during installation.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A retractable canopy system for a light-weight utility vehicle, said system comprising:
a mounting frame comprising a pair of legs, each leg frictionally retainable at an upper portion between corresponding vehicle roof support side struts and fixedly connectable to a fixed structure of the vehicle at distal ends;
at least one deployment frame pivotally connected to the mounting frame legs; and
a canopy attached to the mounting frame and the deployment frame.

2. The system of claim 1, wherein each mounting frame leg comprises a retention system for frictionally retaining each leg in physical communication with the corresponding vehicle roof support side strut absent a side strut invasive fastener.

3. The system of claim 2, wherein each retention system comprises a pair of binding pins spaced apart such that the corresponding roof support side strut is positionable between the binding pins to frictionally retain the mounting frame between the roof support side struts.

4. The system of claim 2, wherein the retention system comprises a U-bracket rotationally mounted to each leg such that the corresponding side strut is positionable within the respective U-bracket to frictionally retain the mounting frame between the roof support side struts.

5. The system of claim 1, wherein the vehicle comprises a golf car and each mounting frame leg comprises a mounting bracket at a distal end of the respective leg for fixedly connecting the legs to a golf bag retention yoke.

6. The system of claim 1, wherein the vehicle comprises a golf car and each mounting frame leg comprises a mounting bracket at a distal end of the respective leg for fixedly connecting legs to a utility basket.

7. The system of claim 1, wherein the deployment frame comprises a pair of arms, each arm pivotally connected to a corresponding leg of the mounting frame such that the canopy is movable between a stowed position and a deployed position by moving the deployment frame.

8. A retractable canopy system for a light-weight utility vehicle, said system comprising:
a mounting frame comprising a pair of legs, each leg comprising:
a retention system for frictionally retaining each leg in physical communication with a corresponding vehicle roof support side strut absent a side strut invasive fastener, and
a mounting bracket at a distal end of each leg fixedly connectable to a fixed structure of the vehicle;
at least one deployment frame comprising a pair of arms, each arm pivotally connected to a corresponding leg of the mounting frame; and
a canopy attached to the mounting frame and the deployment frame such that the canopy is movable between a stowed position and a deployed position by moving the deployment frame.

9. The system of claim 8, wherein the retention system comprises a pair of binding pins spaced apart such that the corresponding side strut is positionable between the binding pins to frictionally retain the mounting frame between the roof support side struts.

10. The system of claim 8, wherein the retention system comprises a U-bracket mounted to each leg such that the corresponding side strut is positionable with the respective U-bracket to frictionally retain the mounting frame between the roof support side struts.

11. The system of claim 8, wherein the vehicle comprises a golf car and the mounting bracket of each leg is connectable to a golf bag retention yoke.

12. The system of claim 8, wherein the vehicle comprises a golf car and the mounting bracket of each leg is connectable to a utility basket.

13. A light-weight utility vehicle comprising:
a retractable canopy system, said system comprising:
a mounting frame comprising a pair of legs, each leg frictionally retainable at an upper portion between corresponding vehicle roof support side struts fixedly connectable to a fixed structure of the vehicle at distal ends;
at least one deployment frame pivotally connected to the mounting frame legs; and
a canopy attached to the mounting frame and the deployment frame.

14. The vehicle of claim 13, wherein each mounting frame leg comprises a retention system for frictionally retaining each leg in physical communication with the corresponding vehicle roof support side strut absent a side strut invasive fastener.

15. The vehicle of claim 14, wherein the retention system comprises a pair of binding pins spaced apart such that the corresponding side strut is positionable between the binding pins to frictionally retain the mounting frame between the roof support side struts.

16. The vehicle of claim 14, wherein the retention system comprises a U-bracket mounted to each leg such that the corresponding side strut is positionable with the respective U-bracket to frictionally retain the mounting frame between the roof support side struts.

17. The vehicle of claim 13, wherein the vehicle comprises a golf car and each mounting frame leg comprises a mounting bracket at a distal end of the respective leg for fixedly connecting legs to a golf bag retention yoke.

18. The vehicle of claim 13, wherein the vehicle comprises a golf car and each mounting frame leg comprises a mounting bracket at a distal end of the respective leg for fixedly connecting legs to a utility basket.

19. The vehicle of claim 13, wherein the deployment frame comprises a pair of arms pivotally connected to a corresponding leg of the mounting frame such that the canopy is movable between a stowed position and a deployed position by moving the deployment frame.

20. A method for installing a retractable canopy system on a golf car, said method comprising:
diagonally positioning a mounting frame of a preassembled, operationally ready, single unit retractable canopy system between a pair of golf car roof support side struts, the mounting frame comprising a pair of legs, each leg including a retention mechanism for frictionally retaining at an upper portion of the mounting frame between the roof support side struts;
aligning the retention mechanisms with the roof support side struts;
rotating the retractable canopy system such that the retention mechanisms frictionally engage roof support side struts to frictionally retain the mounting frame between the roof support side struts absent side strut invasive fasteners;
lowering distal ends of the mounting frame legs into contact with a fixed structure of the golf car; and
coupling the mounting frame leg distal ends to the fixed structure, thereby securely installing the preassembled, operationally ready, single unit retractable canopy system on the golf car.
